(19) United States
(12) Patent Application Publication
(10) Pub. No.: US 2024/0101877 A1
(43) Pub. Date: Mar. 28, 2024

(54) PHOTOCURABLE COMPOSITIONS

(71) Applicant: Henkel AG & Co. KGaA, Duesseldorf (DE)

(72) Inventor: Andrew D. Messana, Newington, CT (US)

(21) Appl. No.: 18/514,551

(22) Filed: Nov. 20, 2023

Related U.S. Application Data
(63) Continuation of application No. PCT/US22/33923, filed on Jun. 17, 2022.
(60) Provisional application No. 63/189,808, filed on May 18, 2021.

(51) Int. Cl. C09J 151/08; C08F 290/14; C09J 5/00

(52) U.S. Cl. CPC C09J 151/08; C08F 290/147; C09J 5/00; C09J 2451/00

(57) ABSTRACT

Photocurable compositions are provided herein, which provide a balance of fast curing properties at exposure to radiation in the electromagnetic spectrum and impressive cure through depth.

### BACKGROUND

### Field

The present invention relates to photocurable compositions having a balance of fast curing properties at exposure to radiation in the electromagnetic spectrum and impressive cure through depth.

### Brief Description of Related Technology

Photocurable adhesive compositions are legion, in large measure for medical device assembly applications. Many have been commercialized with physical properties, such as good tack-free cure time, good fixture time, and good tensile strength being promoted. Conspicuously absent from this list is cure through depth.

Cure through depth means the ability of a dispensed sample of a photocurable adhesive to react such that the reacted adhesive is not flowable in the “z” direction. Cure through depth has been an elusive physical property to achieve in photocurable adhesives.

Until now.

### SUMMARY

Provided herein is a photocurable composition that comprises:
(a) a (meth)acrylate component;
(b) a (meth)acrylate-functionalized resin component; and
(c) an initiator component comprising a combination of a photosensitizer and a co-initiator.

When exposed to a source of radiation, such as that which emits radiation at 405 nm at an intensity of for instance 100 mW/cm² for a period of time of at least about 2 seconds to cure the composition, the cured composition exhibits a depth of cure (also called cured through depth or volume) through the volume of the composition.

In one aspect, the present invention provides a photocurable composition comprising (a) isobornyl (meth)acrylate in an amount of about 5 to about 50 percent by weight, such as about 15 to about 40 percent by weight based on the total weight of the composition; (b) N,N-dimethylacrylamide in an amount of from about 20 to about 30 percent by weight based on the total weight of the composition; (c) a (meth)acrylate-functionalized resin in an amount of from about 15 to about 50 percent by weight, such as about 25 to about 35 percent by weight based on the total weight of the composition; and (d) as an initiator component, a combination of an isopropyithioxanthone, and one or more of benzoyl peroxide and/or dicumyl peroxide.

In another aspect, the present invention provides a method of curing the photocurable composition, comprising the steps of applying the inventive composition to at least a first substrate and exposing the composition to radiation in the electromagnetic spectrum, such as may be emitted from a light-emitting diode (“LED”), so as to cure the composition through a depth of cure.

It was surprisingly found that an initiator component comprising a combination of a photosensitizer and a co-initiator provides a depth of cure to the composition as it cures when exposed to radiation in the electromagnetic spectrum, such as may be emitted from an LED. More specifically, the initiator component is a combination of an isopropyithioxanthone as a photosensitizer, and one or more of benzoyl peroxide and/or dicumyl peroxide as a co-initiator.

The components of the inventive compositions—including at least the urethane (meth)acrylate resin component; the (meth)acrylate component; and the initiator component—are mixed together in any order and for a time sufficient to ensure proper dissolution or dispersion. This composition may be cured, when desired, by radiation in the electromagnetic spectrum, such as UV, visible and UV/VIS radiation, particularly 405 nm radiation, as emitted by a LED lamp like a LOCTITE-branded CureJet.

### BRIEF DESCRIPTION OF THE FIGURES

FIG. 1 depicts a bar chart of depth of cure (in millimeters) versus amount (in grams) of various control formulations and samples

FIG. 2 depicts a bar chart of depth of cure (in millimeters) versus intensity (in mW/cm2) of various control formulations and samples.

### DETAILED DESCRIPTION

As noted above, the present invention provides, in one aspect, a photocurable composition comprising:
(a) a (meth)acrylate component;
(b) a (meth)acrylate-functionalized resin component; and
(c) an initiator component comprising a combination of a photosensitizer and a co-initiator.

When exposed to a source of radiation, such as that which emits radiation at 405 nm at an intensity of for instance 100 mW/cm² for a period of time of about 30 seconds, such as about 10 seconds, desirably about 2 seconds, to cure the composition, the cured composition exhibits a depth of cure (also called cured through depth or volume) through the volume of the composition.

In one aspect, the present invention provides a photocurable composition comprising (a) isobornyl (meth)acrylate in an amount of about 5 to about 50 percent by weight, such as about 15 to about 40 percent by weight based on the total weight of the composition; (b) N,N-dimethylacrylamide in an amount of from about 20 to about 30 percent by weight based on the total weight of the composition; (c) a (meth)acrylate-functionalized resin in an amount of from about 15 to about 50 percent by weight, such as about 25 to about 35 percent by weight based on the total weight of the composition; and (d) as an initiator component, a combination of an isopropyithioxanthone, and one or more of benzoyl peroxide and/or dicumyl peroxide.

In another aspect, the present invention provides a method of curing the photocurable composition, comprising the steps of applying the inventive composition to at least a first substrate and exposing the composition to radiation in the electromagnetic spectrum, such as may be emitted from a light-emitting diode (“LED”), so as to cure the composition through a depth of cure or through the volume of the composition.

It was surprisingly found that an initiator component comprising a combination of a photosensitizer and a co-initiator provides a depth of cure to the composition as the composition cures when exposed to radiation in the electromagnetic spectrum, such as may be emitted from an LED. More specifically, the initiator component is a combination of an isopropylthioxanthone as a photosensitizer, and one or more of benzoyl peroxide and/or dicumyl peroxide as a co-initiator. Ordinarily, photocurable compositions with only a photosensitizer form a skin over layer at the surface of the composition and provide little to no cure through depth without the presence of an amine synergist or secondary cure mechanism, such as moisture cure or anaerobic cure. Here, however, the inventive compositions exhibit a depth or cure through the volume of the composition when so exposed to radiation in the electromagnetic spectrum

The (meth)acrylate component may include a host of (meth)acrylate monomers, with some of the (meth)acrylate monomers being aromatic, while others are aliphatic and still others are cycloaliphatic. Examples of such (meth)acrylate monomers include di-or tri-functional (meth)acrylates like polyethylene glycol di(meth)acrylates, tetrahydrofuran (meth)acrylates and di(meth)acrylates, hydroxypropyl (meth)acrylate (“HPMA”), hexanediol di(meth)acrylate, trimethylol propane tri(meth)acrylate (“TMPTMA”), diethylene glycol dimethacrylate, triethylene glycol dimethacrylate (“TRIEGMA”), benzylmethacrylate, tetraethylene glycol dimethacrylate, dipropylene glycol dimethacrylate, di-(pentamethylene glycol) dimethacrylate, tetraethylene diglycol diacrylate, diglycerol tetramethacrylate, tetramethylene dimethacrylate, ethylene dimethacrylate, neopentyl glycol diacrylate, trimethylol propane triacrylate and bisphenol-A mono and di(meth)acrylates, such as ethoxylated bisphenol-A (meth)acrylate (“EBIPMA”), and bisphenol-F mono and di(meth)acrylates, such as ethoxylated bisphenol-F (meth)acrylate.

The (meth)acrylate component should be present in an amount of about 25 percent by weight to about 80 percent by weight, such as about 55 percent by weight to about 65 percent by weight, based on the total weight of the composition.

Particularly desirable (meth)acrylate monomers include isobornyl (meth)acrylate and N,N-dimethylacrylamide, which may be used in combination.

When used in combination, (a) isobornyl (meth)acrylate should be used in an amount of about 5 percent by weight to about 50 percent by weight, such as about 15 percent by weight to about 40 percent by weight based on the total weight of the composition, and (b) N,N-dimethylacrylamide should be used in an amount of from about 20 percent by weight to about 30 percent by weight based on the total weight of the composition.

The (meth)acrylate-functionalized resin component includes oligomers, particularly oligomers with urethane linkages, having a number average molecular weight of from about 500 to about 100,000 Mn, such as about 2,500 to about 25,000 Mn. The number average molecular can be measured for example by gel permeation chromatography.

In one aspect, the inventive compositions include a (meth)acrylate-functionalized resin component present in an amount of from about 15 percent by weight to about 50 percent by weight, such as about 25 percent by weight to about 35 percent by weight based on the total weight of the composition.

Examples of a (meth)acrylate-functionalized resin are (meth)acrylate-functionalized urethanes, (meth)acrylate-functionalized polyesters, and poly(isobutylene) di(meth)acrylates.

(Meth)acrylate-functionalized urethanes (or urethane (meth)acrylate resins) suitable as the (meth)acrylate-functionalized resin component include those disclosed in U.S. Pat. Nos. 4,018,851, 4,295,909 and 4,309,526 to Baccei, and U.S. Pat. Nos. Re 33,211, 4,751,273, 4,775,732, 5,019,636 and 5,139,872 to Lapin et al., for instance.

Other examples of such (meth)acrylate-functionalized urethanes include a tetramethylene glycol urethane acrylate oligomer and a propylene glycol urethane acrylate oligomer.

Still other (meth)acrylate-functionalized urethanes are monofunctional urethane acrylate oligomers, such as a polypropylene terminated with 4,4′-methylenebis(cyclohexylisocyanate), capped with 2-hydroxyethyl acrylate and 1-dodosanol.

They also include difunctional urethane methacrylate oligomers such as a polytetramethylene glycol ether terminated with tolulene-2,4-diisocyanate, capped with 2-hydroxyethyl methacrylate; a polytetramethylene glycol ether terminated with isophorone diisocyanate, capped with 2-hydroxyethyl methacrylate; a polytetramethylene glycol ether terminated with 4,4′-methylenebis(cyclohexylisocyanate), capped with 2-hydroxyethyl methacrylate; and a polypropylene glycol terminated with tolylene-2,4-diisocyanate, capped with 2-hydroxyethyl methacrylate.

The (meth)acrylate-functionalized resin component may be a multi- (such as di- or tri-) functional urethane acrylate oligomer, more desirably an aliphatic polyether urethane acrylate. An example of a suitable (meth)acrylate-functionalized resin component is BR-582-E8 (commercially available from Dymax Corporation, Torrington, CT), which is described as an aliphatic urethane acrylate oligomer having a polyether backbone. BR-582-E8 is listed in the tables below.

Dymax also makes available commercially a series of other (meth)acrylate-functionalized urethanes, which have a functionality of between about 1 and about 3 and demonstrate a percent elongation of greater than about 50. One such (meth)acrylate-functionalized urethane from Dymax is a tri-functional urethane acrylate oligomer, more specifically an aliphatic polyether urethane triacrylate, known as BR-990.

Among the (meth)acrylate-functionalized urethanes are those based on polyesters or polyethers, which are reacted with aromatic, aliphatic, or cycloaliphatic diisocyanates and capped with hydroxy acrylates.

For instance, difunctional urethane acrylate oligomers, such as a polyester of hexanedioic acid and diethylene glycol, terminated with isophorone diisocyanate, capped with 2-hydroxyethyl acrylate (CAS 72121-94-9); a polypropylene glycol terminated with tolyene-2,6-diisocyanate, capped with 2-hydroxyethylacrylate (CAS 37302-70-8); a polyester of hexanedioic acid and diethylene glycol, terminated with 4,4′-methylenebis(cyclohexyl isocyanate), capped with 2-hydroxyethyl acrylate (CAS 69011-33-2); a polyester of hexanedioic acid, 1,2-ethanediol, and 1,2 propanediol, terminated with tolylene-2,4-diisocyanate, capped with 2-hydroxyethyl acrylate (CAS 69011-31-0); a polyester of hexanedioic acid, 1,2-ethanediol, and 1,2 propanediol, terminated with 4,4′-methylenebis(cyclohexyl isocyanate, capped with 2-hydroxyethyl acrylate (CAS 69011-32-1); and a polytetramethylene glycol ether terminated with 4,4′-methylenebis(cyclohexylisocyanate), capped with 2-hydroxyethyl acrylate.

The following commercially available (meth)acrylate-functionalized urethane resins from Dymax that may be useful include BR-930D [described by the manufacturer as a polyether urethane acrylate that is flexible and has weatherability, with a nominal viscosity of 7,700 at 60° C. and a Tg (° C.) by DMA of 95. The manufacturer promotes BR-930D as having the following features for select applications ideal for 3D printing resins; high heat-distortion temperature; provides good toughness and impact resistance; enhances weatherability and low skin irritation]; and BR 7432G130 [described by the manufacturer as a polyester urethane acrylate that is flexible and has weatherability, with a nominal viscosity of 80,000 at 25° C. and a Tg (° C.) by DMA of 28. The manufacturer promotes BR-7432G130 as having the following features for select applications: imparts toughness; high tensile strength; improves impact resistance; adheres to polymer films; elastomeric; and BR-3741AJ [described by the manufacturer as a polyether urethane acrylate that is flexible and has weatherability, with a nominal viscosity of 25,000 at 60° C. and a Tg (° C.) by DMA of −50. The manufacturer promotes BR-3741AJ as having the following features for select applications: enhances softness and flexibility; improved optical clarity; non-yellowing; improves adhesion; adheres to a wide range of substrates; exhibits hydrolytic stability; oil and chemical resistant and ideal for PSAs].

Thus, (meth)acrylate-functionalized urethanes may be chosen from a variety of materials, some of which are commercially available from Dymax and are recited below in the tables together with certain salient features:

Polyester Urethane Acrylates

| | | Elongation at |
|---|---|---|
| Name | Functionality | Break, % |
| BR-744BT | 2 | 407 |
| BR-744SD | 2 | 321 |
| BR-7432GB | 2 | 350 |
| BR-7432GI30 | 2 | 260 |

Polyester Urethane Methacrylates

| | | Elongation at |
|---|---|---|
| Name | Functionality | Break, % |
| BR-742M | 2 | 60 |
| BR-742MS | 2 | 60 |

Polyether Urethane Acrylates

| | | Elongation at |
|---|---|---|
| Name | Functionality | Break, % |
| BR-302 | 2 | 102.5 |
| BR-343 | 2 | 57 |
| BR-344 | 2 | 110 |
| BR-345 | 2 | 260 |
| BR-372 | 2 | 90 |
| BR-374 | 2 | 285 |
| BR-541S | 2 | 120 |
| BR-543 | 2 | 200 |
| BR-571 | 2 | 115 |
| BR-582-E8 | 2.4 | 180 |
| BR-582H15 | 2.4 | 65 |
| BR-582I10 | 2.4 | 180 |
| BR-3042 | 2 | 500 |
| BR-3641AA | 1.3 | 580 |
| BR-3641AJ | 1.3 | 2,900 |
| BR-3741 | 2 | 152 |
| BR-3741AJ | 1.3 | 1,000 |
| BR-5825130 | 2.4 | 130 |

Polyether Urethane Methacrylates

| | | Elongation at |
|---|---|---|
| Name | Functionality | Break, % |
| BR-116 | 3 | 57 |
| BR-202 | 2 | 75 |
| BR-204 | 2 | 160 |
| BR-541MB | 2 | 63 |
| BR-543MB | 2 | 51 |
| BR-551M | 2 | 74 |
| BR-551ME | 2 | 60 |
| BR-571MB | 2 | 110 |
| XR-145S | 3 | 140 |

As an example, the BR-345 (meth)acrylate-functionalized urethane may be made according to the following reaction scheme:

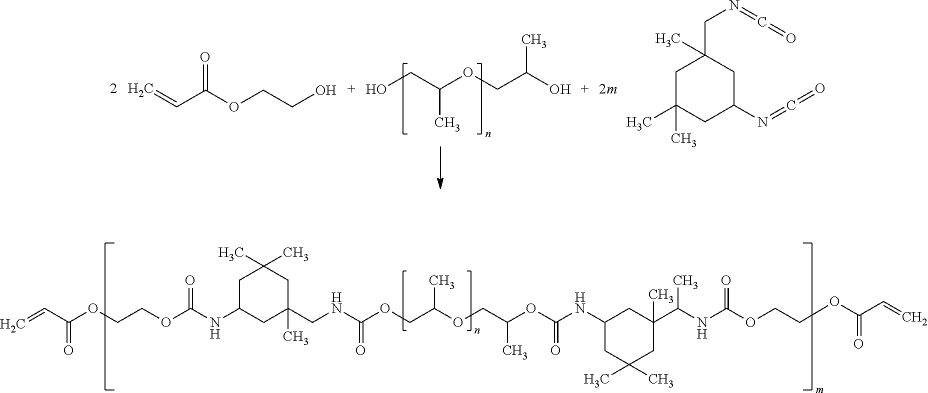

Another example of a useful (meth)acrylate-functionalized urethane is a block resin noted as cyclohexanol, 4,4-(1-methylethylidene)bis-, polymer with 1,3-disocyanatomethylbenzene and tetrahydrofuran, propylene glycol monomer (CAS No. 2243075-64-9), made in sequential steps from the reaction of the propylene glycol monomer and dicarboxylic acids to form polyester diols, followed by reaction with toluene diisocyanate and finally capping with hydroxy propyl(meth)acrylate.

Still another example of a useful (meth)acrylate-functionalized urethane is a block resin made from a saturated polyester diol (such as one sold under the tradename DESMOPHEN S-1011-35) and dicyclohexylmethane-4,4′-diisocyanate (available commercially as DESMODUR W), and capping with 2-hydroxy ethyl acrylate, the block resin being diluted with IBOA.

A resin containing a central segment of POLYMEG 2000 (polytetramethylene ether glycol produced by polymerizing tetrahydrofuran to form a linear diol with a backbone of repeating tetramethylene units connected by ether linkages, and capped with primary hydroxyl units) to which are attached through urethane linkages either TDI-HBPA or IPDI-HMTD and capped with either TDI-HPMA or IPDI-HEMA may be used. Also, a resin made from a hydroxy functionalized polyether, polyester (available commercially as KURARAY Polyol P-2010) and TDI, together with hydroxypropyl (meth)acrylate and isobornyl (meth)acrylate may be used. Likewise, a resin made from polyTHF (with a weight average molecular weight (“Mw”) of 2,000) and TDI, together with HBPA, hydroxypropyl (meth)acrylate, hydroxyethyl (meth)acrylate and isobornyl (meth)acrylate may also be used.

In some cases, such as described in U.S. Pat. No. 10,745,590, hydrophobic (meth)acrylate-functionalized urethanes may be desirable, such as those having a Mw of 35000 to 60000 g/mol, as determined by gel permeation chromatography (“GPC”). With the Mw falling within this range, the cured products may also demonstrate strong cohesion and high elongation. Preferably, hydrophobic (meth)acrylate-functionalized urethanes should have a functionality of the (meth)acrylate group of equal to or less than 2. With the functionality of the (meth)acrylate group falling within this range, the cured products may also demonstrate high elongation. These hydrophobic (meth)acrylate-functionalized urethanes should have a glass transition temperature value (“Tg”) of from −60° C. to 20° C., as determined by differential scanning calorimetry (“DSC”).

Hydrophobic (meth)acrylate-functionalized urethanes may be selected from aliphatic urethane (meth)acrylates, aromatic urethane (meth)acrylates and mixtures thereof, such as polybutadiene-based urethane (meth)acrylates, polyisobutylene based urethane (meth)acrylates, polyisoprene based urethane (meth)acrylate, polybutyl rubber based urethane (meth)acrylates and the mixtures thereof. Suitable commercially available hydrophobic urethane (meth)acrylates include UT-4462 and UV36301B90 available from Nippon Gohsei; CN 9014 available from Sartomer; and SUO-H8628 available from SHIIN-A T&C.

(Meth)acrylate-functionalized urethanes may also include polyurethane block copolymer having a backbone of alternating hard and soft segments and at least two ends. The ends each may be terminated with a vinyl ether, alkenyl ether or (meth)acrylate group. Such polyurethane block copolymers may be represented by the following general formula:

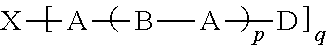

wherein A is a hard segment, such as the reaction product of a polyisocyanate and an aromatic, heterocyclic or cycloaliphatic polyol;
B is a divalent soft segment and X is a q-valent soft segment, such as where B and X may be a divalent and a multivalent group, respectively, derived from a polyether polyol, polyester polyol or hydrogenated hydrocarbon elastomer, such as polybutadiene;
D is a vinyl ether or (meth)acrylate group, such as where the vinyl ether may be derived from hydroxy functional vinyl ethers, for instance 2-hydroxyethyl vinyl ether, 4-hydroxybutyl vinyl ether, cyclohexanedimethanol monovinyl ether, diethylene glycol monovinyl ether, 1,6-hexanediol monovinyl ether and 3-aminopropyl vinyl ether, or the vinyl ether terminal groups may be derived from an amino functional vinyl ether, in which case vinyl ether urea capped polyurethanes may be obtained;
p is 0-10; and
q is 2-6.

Another example of a (meth)acrylate-functionalized urethane is one with a polyurethane backbone, at least a portion of which includes a urethane linkage formed from isophorane diisocyanate. For instance, such a (meth)acrylate-functionalized urethane is made from an alkylene glycol (such as polypropylene glycol), isophorane diisocyanate and hydroxy alkyl(meth)acrylate (such as hydroxyl ethyl acrylate). Other examples include a polyester of hexanedioic acid, diethylene glycol, terminated with isophorone diisocyanate, capped with 2-hydroxyethyl acrylate; a polytetramethylene glycol ether terminated with isophorone diisocyanate, capped with 2-hydroxyethyl methacrylate; and a hydroxy terminated polybutadiene terminated with isophorone diisocyanate, capped with 2-hydroxyethyl acrylate.

The initiator component comprising a combination of a photosensitizer and a co-initiator.

The initiator component should be present in an amount from about 0.01 percent by weight to about 5 percent by weight, such as from about 0.5 percent by weight to about 4 percent by weight by weight based on the total weight of the composition.

The photosensitizer component may be one that is commercially available from Lambson an Arkema company. For instance, Lambson makes available a number of photosensitizers including SpeedCure CPTX, SpeedCure DETX, and SpeedCure ITX. SpeedCure CPTX is described as a Norrish Type II photoinitiator of the thioxanthone family, with absorption maxima at 257, 214 and 389 nm. Lambson indicates that SpeedCure CPTX provides long wavelength sensitisation of appropriate photoinitiators and depth cure when used at 0.1-5 wt % and combined with an amine synergist in UV and LED curable formulations. The chemical name is 1-chloro-4-propoxythioxanthone. SpeedCure DETX is described as a Norrish Type II photoinitiator of the thioxanthone family, with absorption maxima at 261, 291 and 386 nm. SpeedCure DETX provides long wavelength sensitisation of appropriate photoinitiators and depth cure when used at 0.1-5 wt % and combined with an amine synergist in UV and LED curable formulations. The chemical name is 2,4-diethylthioxanthone. SpeedCure ITX is described as a Norrish Type H photoinitiator of the thioxanthone family, with absorption maxima at 259 and 383 nm. SpeedCure ITX provides long wavelength sensitisation of appropriate photoinitiators and depth cure when used at 0.1-5 wt % and combined with an amine synergist in UV and LED curable formulations. The chemical name is isopropylthioxanthones, and SpeedCure ITX is a mixture of 2-isopropylthioxanthone and 4-isopropylthioxanthone.

Desirably, the photosensitizer component should comprise isopropylthioxanthones.

As promoted by the manufacturer, these SpeedCure-branded photosensitizers are to be used together with an amine synergist. In the present invention, remarkable results have been achieved without the presence of such an amine synergist.

The co-initiator may be selected from a host of materials, provided the co-initiator acts by way of a free radical mechanism. The co-initiators should be chosen from one or more of a benzoyl peroxide and a dicumyl peroxide.

The photosensitizer component may be present in an amount from about 0.01 percent by weight to about 5 percent by weight, such as from about 0.1 percent by weight to about 4 percent by weight by weight based on the total weight of the composition.

The co-initiator may be present in an amount from about 0.01 percent by weight to about 5 percent by weight, such as from about 0.1 percent by weight to about 4 percent by weight by weight based on the total weight of the composition.

The inventive composition may also include one or more additives, such as colorants like pigments or dyes. Carbon black is one such colorant and may be used in an amount of about 0.0025 percent by weight to about 5 percent by weight of the composition, such as about 0.1 percent by weight to about 1 percent by weight of the composition. Titanium dioxide is another useful colorant and may be used in an amount of about 0.01 percent by weight to about 3 percent by weight of the composition, such as about 0.1 percent by weight to about 1 percent by weight of the composition. In addition, colorants in the form or dyes or pigments may be used, and selected from red, yellow, blue, green and violet, for instance.

In one aspect, the present invention provides a method of curing the inventive compositions comprising the steps of applying the compositions to at least a first substrate and exposing the composition to radiation in the electromagnetic spectrum, such as may be emitted from an LED source like those described herein.

At least one substrate may be a plastics material, which desirably should be transparent to UV, visible or UV/VIS light. By way of example, the plastics material which is desirably transparent to such radiation can be selected from at least one of polyvinyl chloride, polyethylene, polypropylene, polycarbonate, acrylonitrile butadiene styrene, polyethylene terephthalate and thermoplastic elastomers.

At least one of the first substrate and the second substrate to be bonded using a composition of the invention can comprise tubing:
(i) for the transfer, including drainage, of medical fluids including liquids such as electrolyte e.g. saline or blood and gases such as oxygen;
(ii) in a form which is inserted into the body, such as a catheter, for example for insertion within the vasculature, or for insertion within a tract such as a urinary tract;
(iii) part of an implantable device;
(iv) for connecting to a cannula which is for insertion into a subject for example an intravenous catheter;
(v) for connecting to a medical device such as a pump, including insulin pumps, or haemodialysis equipment;
(vi) for use as a sheath, for example to house wires, for example to house wires from medical equipment.

### EXAMPLES

The inventive compositions cure in less than about 30 seconds, such as less than about 10 seconds, typically less than about 5 seconds, such as about 2 seconds, upon exposure to radiation in the electromagnetic spectrum for example at an intensity of 100, 200 or 400 mW/cm² using LED light sources which emit light at a wavelength of 405 nm.

Initially, a model formulation was prepared from isobornyl acrylate, 35 percent by weight; N,N-dimethylacrylamide, 35 percent by weight; and BOMAR BR 582-E8, 30 percent by weight. BOMAR BR-582-E8 is an aliphatic polyether urethane acrylate oligomer, which is said by the manufacturer, Dymax Corporation, Torrington, CT, to provide a balance of toughness and flexibility. Dymax highly recommends this oligomer product for use in single-coat, flexible coatings on metal and plastic substrates and is an excellent choice for impact and bend resistant coatings, demonstrating abrasion resistance, flexibility, gloss, hydrolytic stability, weather resistance and non-yellowing properties too. Dymax reports the oligomer product to have a Tg by DMA of 23° C. and a nominal viscosity of 60,000 cP at 50° C., and to bond to a variety of substrates, though not to high density polyethylene.

To the model formulation was added with mixing 1.0 percent by weight of SpeedCure ITX to create Sample No. 1, and 0.5 percent by weight of LUPEROX A98 (anhydrous benzoyl peroxide) together with 1 percent by weight of SpeedCure ITX to create Sample No. 2.

A 30 g volume of these samples (Sample Nos. 1-2) was dispensed separately into a plastic beaker and exposed for 10 seconds to radiation in the electromagnetic spectrum emitted from a LOCTITE-branded 405 nm Flood Array and cured at 200 mW/cm² light intensity.

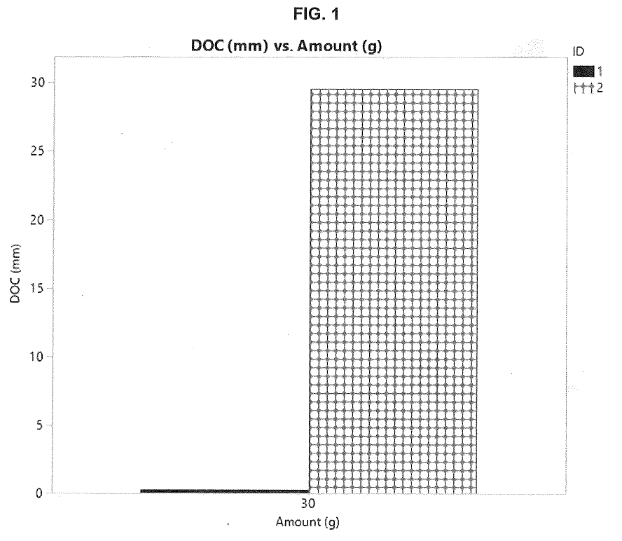

Comparing the depth of cure observed for Sample Nos. 1-2, one can see a pronounced increase in the depth of cure with a 10 second exposure. Table 1 below captures the data observed and FIG. 1 depicts that data visually in a bar chart.

TABLE 1
Sample No.

| 1 | 2 |
|---|---|
| DOC (mm) | DOC (mmn) |
| Max | Max |
| 0.25 | 29.59 |

In another example, to a model formulation 1.0 percent by weight of SpeedCure ITX was added with mixing together with a black pigment to create Sample No. 3. The black pigment was carbon black (MONARCH 700) in an amount of 0.1 percent by weight.

Then, to the model formulation in addition to 1.0 percent by weight of SpeedCure ITX and 0.5 percent by weight of LUPEROX A98 (anhydrous benzoyl peroxide) was added with mixing one of a black pigment, a white pigment, a red dye and a green dye to create Sample Nos. 4-7. Here again, the black pigment was carbon black (MONARCH 700) in an amount of 0.1 percent by weight. The white pigment was titanium dioxide (Ti-Pure R-706) in an amount of 0.5 percent by weight. The red dye was solvent red 24 in an amount of 0.2 percent by weight whose structure is:

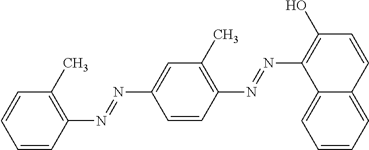 [SMILES: Cc1ccccc1/N=N/c1ccc(/N=N/c2c(O)ccc3ccccc23)c(C)c1]

The green dye was solvent green 3 in an amount of 0.1 percent by weight whose structure is:

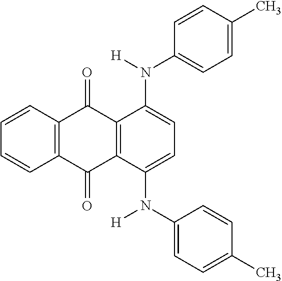 [SMILES: Cc1ccc(Nc2ccc(Nc3ccc(C)cc3)c3c2C(=O)c2ccccc2C3=O)cc1]

Then, to the model formulation in addition to 1.0 percent by weight of SpeedCure ITX and 0.5 percent by weight of LUPEROX A98 (anhydrous benzoyl peroxide) was added with mixing the red dye though in an amount of 0.1 percent by weight instead of the 0.2 percent by weight used in Sample No. 6. Thus, Sample No. 8 was created.

These samples were dispensed in 30 gram portions into a 50 mL plastic beaker and exposed to radiation in the electromagnetic spectrum emitted from a LOCTITE-branded 405 nm CureJet at either 200 mW/cm² or 400 mW/cm² light intensity for 30 seconds. Table 2 below captures the data observed at 200 mW/cm² light intensity.

TABLE 2
Sample No.

| 3 | 4 | 5 | 6 | 7 |
|---|---|---|---|---|
| DOC | DOC | DOC | DOC | DOC |
| (mm) | (mm) | (mm) | (mm) | (mm) |
| Max | Max | Max | Max | Max |
| 1.0 | 28.5 | 29.8 | 0.8 | 2.3 |

Table 3 below captures the data observed with Sample No. 8 at 400 mW/cm² light intensity.

TABLE 3
Sample No.
8
DOC (mm)
Max
30.0

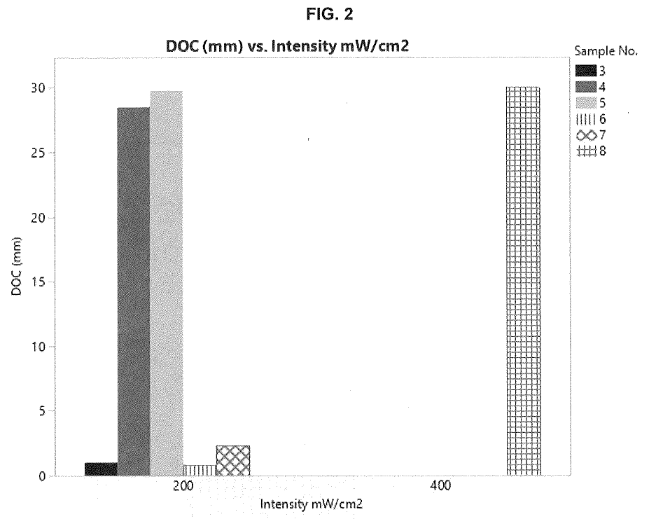

The information captured in Table 3 shows depth of cure for Sample No. 8, which contains red dye but was exposed to 400 mW/cm² light intensity instead of 200 mW/cm² light intensity as was the case with Sample No. 6. That depth of cure is over 30 times as significant than the depth of cure observed with the lower intensity light. FIG. 2 shows the data from Tables 2 and 3 in graphic representation.

What is claimed is:

1. A photocurable composition comprising:
(a) a (meth)acrylate component;
(b) a (meth)acrylate-functionalized resin component; and
(c) an initiator component comprising a combination of a photosensitizer and a co-initiator.

2. The composition of claim 1, wherein the initiator component excludes an amine synergist.

3. The composition of claim 1, wherein the photosensitizer comprises a 1-chloro-4-propoxythioxanthone, 2,4-diethylthioxanthone, isopropylthioxanthones, and combinations thereof.

4. The composition of claim 1, wherein the co-initiator comprises one or more peroxides.

5. The composition of claim 1, wherein the co-initiator comprises one or more of benzoyl peroxide and dicumyl peroxide.

6. The composition of claim 1, wherein the (meth)acrylate component comprises isobornyl (meth)acrylate and N,N-dimethylacrylamide.

7. The composition of claim 1, wherein the (meth)acrylate component is present in the range of about 25 percent by weight to about 80 percent by weight based on the total weight of the composition.

8. The composition of claim 1, wherein the (meth)acrylate-functionalized resin component comprises one or more of (meth)acrylate-functionalized urethanes, (meth)acrylate-functionalized polyesters, and poly(isobutylene) di(meth)acrylates.

9. The composition of claim 1, wherein the (meth)acrylate-functionalized resin component resin has a number average molecular weight of from about 500 to about 100,000.

10. The composition of claim 1, wherein the (meth)acrylate-functionalized resin component is present in an amount from about 15 percent by weight to about 50 percent by weight based on the total weight of the composition.

11. The composition of claim 1, wherein the (meth)acrylate-functionalized resin component is present in an amount from about 25 percent by weight to about 35 percent by weight based on the total weight of the composition.

12. The composition of claim 6, wherein the isobornyl (meth)acrylate of the (meth)acrylate component is present in an amount from about 5 percent by weight to about 50 percent by weight based on the total weight of the composition.

13. The composition of claim 6, wherein the isobornyl (meth)acrylate of the (meth)acrylate component is present in an amount from about 15 to about 40 percent by weight based on the total weight of the composition.

14. The composition of claim 6, wherein the N,N-dimethylacrylamide is present in an amount from about 20 percent by weight to about 30 percent by weight based on the total weight of the composition.

15. The composition of claim 1, wherein the initiator component comprises an isopropylthioxanthone as a photosensitizer, and one or more of benzoyl peroxide and dicumyl peroxide as a co-initiator.

16. The composition of claim 1, wherein the initiator component is present in an amount from about 0.01 percent by weight to about 5 percent by weight based on the total weight of the composition.

17. The composition of claim 1, wherein the photosensitizer of the initiator component is present in an amount from about 0.5 percent by weight to about 5 percent by weight based on the total weight of the composition.

18. The composition of claim 1, wherein the co-initiator of the initiator component is present in an amount from about 0.01 percent by weight to about 3 percent by weight based on the total weight of the composition.

19. The composition of claim 1, wherein the photosensitizer and the co-initiator of the initiator component are present in a by weight ratio of about 1:1 to about 500:1.

20. The composition of claim 1, further comprising a colorant.

21. The composition of claim 1, comprising
(a) isobornyl (meth)acrylate in an amount of about 15 percent by weight to about 40 percent by weight based on the total weight of the composition;
(b) N,N-dimethylacrylamide in an amount of from about 20 percent by weight to about 30 percent by weight based on the total weight of the composition;
(c) (meth)acrylate-functionalized resin in an amount of from about 25 percent by weight to about 35 percent by weight based on the total weight of the composition; and
(d) as an initiator component, a combination of an isopropylthioxanthone, and one or more of benzoyl peroxide and/or dicumyl peroxide.

22. The composition of claim 1, wherein the (meth)acrylate-functionalized resin component is cyclohexanol, 4,4-(1-methylethylidene)bis-, polymer with 1,3-disocyanatomethylbenzene and tetrahydrofuran, propylene glycol monomer.

23. The composition of claim 1, when exposed to a source of radiation at 405 nm at an intensity of 100 mW/cm² for a period of time of at least about 2 seconds to cure the composition, the cured composition exhibits a depth of cure through a volume of the composition.

24. A method of curing a photocurable composition according to claim 1 comprising the steps of:
(a) applying a volume of the composition to at least a first substrate; and
(b) exposing the composition to a source of radiation at 405 nm at an intensity of 100 mW/cm² to cure the composition through a volume of the composition.

25. The method according to claim 24, comprising bonding the first substrate to a second substrate, wherein the first substrate and the second substrate are each parts of medical devices and optionally thereafter sterilizing the bonded assembly created by bonding the first substrate to the second substrate.
